(19) United States
(12) Patent Application Publication
(10) Pub. No.: US 2004/0174338 A1
(43) Pub. Date: Sep. 9, 2004

(54) Intelligent docking station for a handheld personal computer

(76) Inventor: Bryan A. Scott, Plano, TX (US)

Correspondence Address: Steven Thrasher, 391 Sandhill Dr., Richardson, TX, 75080, US

(21) Appl. No.: 10/801,974

(22) Filed: Mar. 15, 2004

Related U.S. Application Data
(63) Continuation-in-part of application No. 10/288,846, filed on Nov. 6, 2002.

(51) Int. Cl. G09G 5/00

(52) U.S. Cl. 345/156

(57) ABSTRACT

The invention is an intelligent docking station that enables a user to input data into a PDA through a plurality of modes.

### RELATED APPLICATIONS

This patent application is a continuation in part of, is related to, and claims priority from co-owned and assigned U.S. patent application Ser. No. 10/288,846 to Scott, et al. entitled Manipulating the position of a horizontal-vertical visual indicator on a PDA display via a one-hand manual screen horizontal-vertical visual indicator device, filed on Nov. 6, 2002, which is entirely incorporated by reference herein.

### TECHNICAL FIELD OF THE INVENTION

The invention relates to PDA data entry.

### PROBLEM STATEMENT

Interpretation Considerations This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

PCs are typically bulky, require large amounts of power, and occupy a large amount of surface area, called a “footprint.” “Handhelds” or personal digital assistants (PDAs), provide significant computing power in a small device that uses relatively little power. Unfortunately, handhelds do not offer the most user-friendly input/output devices, such as a keyboard and mouse. Instead, a user of a handheld must be content with using a stylus, very small buttons, or other data entry devices. Accordingly, it is desirable to provide a device, system, and method for integrating the conveniences of a handheld with the conveniences of a PC. The invention provides such devices, systems, and methods.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a block diagram of a limited feature intelligent docking station cradle (the cradle); and

FIG. 2 is a block-flow diagram of a cradle algorithm.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Handheld Computer Systems as Software Platforms

A handheld computer system typically comprises hardware capable of executing machine-readable instructions, as well as software for executing acts typically as machine-readable instructions that produce a desired result. In addition, a handheld computer system may include hybrids of hardware and software, as well as computer sub-systems.

Software may be defined as machine code stored in memory, such as RAM or ROM, or machine code stored on devices (such as memory card, for example). Software may include executable code, an operating system, or source or object code, for example. In addition, software encompasses any set of instructions capable of being executed in a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method that comprises acts. In the present discussion, sometimes acts are referred to as steps to help the reader more completely understand the exemplary embodiment.

Software also includes description code. Description code specifies variable values and uses these values to define attributes for a display, such as the placement and color of an item on a displayed page. For example, the Hypertext Transfer Protocol (HTTP) is the software used to enable the Internet and is a description software language.

Hybrids (combinations of software and hardware) are becoming more common as devices for providing enhanced functionality and performance to computer systems. A hybrid is created when traditionally software functions are directly manufactured into a silicon chip-this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Handheld computer sub-systems are combinations of hardware or software (or hybrids) that perform some specific task. For example, one computer sub-system is a soundcard. For example, a soundcard provides hardware connections, memory, and hardware devices for enabling sounds to be produced and recorded by a handheld computer system. Likewise, a soundcard may also include software needed to enable a computer system to “see” the soundcard, recognize the soundcard, and drive the soundcard.

Methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

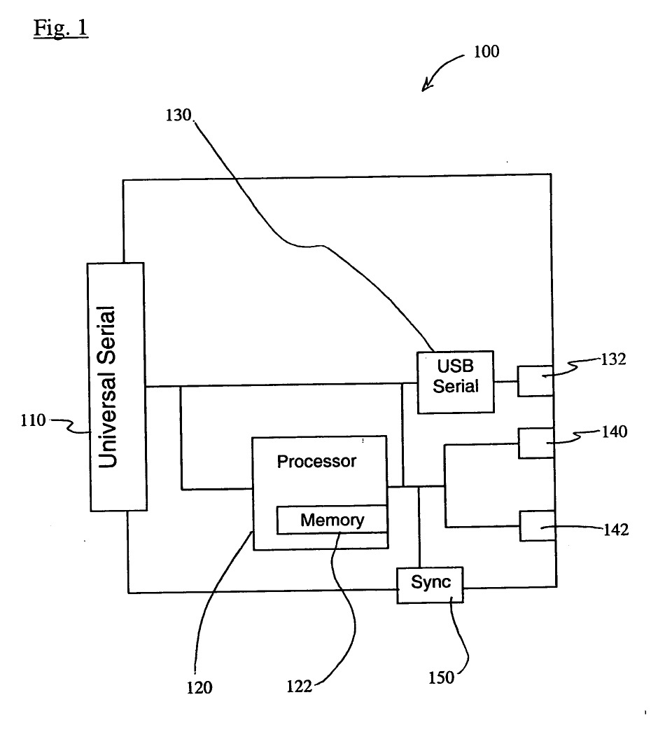

Reference is now made to the figures, and in particular with reference to FIG. 1, which illustrates a block diagram of a limited feature intelligent docking station cradle (the cradle) 100 that supports unidirectional data flow from the cradle 100 to a PDA. The cradle 100 generally defines components, architecture, methods, and feature sets that enable a user to more easily interface with a PDA. The cradle 100 typically includes a port 110 that is a means for coupling the cradle 100 to a handheld computing device such as a smart phone, or personal digital assistant (PDA), for example, and is preferably a Universal Serial Palm Connector. Hereinafter, the exemplary embodiment is discussed with respect to a PDA, but is equally applicable to any handheld computing device. Of course, other ports for coupling a PDA to another device are known in the art (both via hardware and wireless connections), and any such coupling is within the scope of the invention.

Additionally, a cradle 100 also includes a processor 120, such as a digital signal processor (DSP) available from Texas Instruments®. The processor 120 provides functionality to the cradle 100, and more specifically, the processor 120 is configured to allow the cradle 100 to couple a keyboard and/or mouse to a PDA that is coupled to the cradle 100. The processor 120 also facilitates communication with the cradle's client docking software, and also facilitates keyboard and mouse data aggregation and data transmission to the client docking software. Included on the processor is ROM 122, preferably EEPROM, which stores an embedded operating system that is adapted to provide functionality to an embedded software.

The cradle 100 includes ports that couple to input devices. Preferably, the cradle includes a second port, preferably a keyboard port 140, and a third port that is preferably a mouse port 142. Of course, input devices are known in the art as passive devices that allow a user to communicate with a computing device, and do not typically have processing power of their own. An optional USB serial chip 130 enables data to be transmitted and received by a PDA via direct communication with a device, such as a computer, laptop, or MP3 player, for example, which is coupled to the USB port 132, such as a USB 1.1 port. Accordingly, when in a first state defined by a non-synced PDA connection with the cradle 100, the USB serial chip “sleeps,” allowing the cradle 100 to operate as an I/O device with a coupled PDA. However, when in a second state defined by syncing operation whereby a PDA is syncing with a device (not the cradle 100, or an input device), the keyboard port 140 and the mouse port 142 are disabled (or all keyboard and mouse events are stored, effectively disabling the keyboard and mouse).

The keyboard port 140 and the mouse port 142 are preferably common PS2 ports (PS2 keyboard port and PS2 mouse port), which are commonly used on PCs. For example, a PS2 keyboard port couples to a standard 104 keyboard, and a PS2 mouse port couples to a standard two or three button mouse, or mouse with a scroll wheel, such as an Intellimouse®. However, it should be understood that while PS2 ports are preferred, other ports, including wireless ports and USB ports are known in the computer art, are apparent after reading the present disclosure, and may be incorporated into the invention without departing from its scope. Also included is a synchronization button 150, which has functionality and operation known in the art.

Embedded software resident on the cradle is preferably embedded in the ROM 422. The embedded software provides several aspects to cradle functionality. First, the embedded software is adapted to initiate a docking event when it is detected that a PDA is coupled to the port 110. Following the docking event, the embedded software establishes a communication link between the PDA and client docking software. Second, after docking, the embedded software activates the communication link by detecting serial keyboard and mouse data on the respective ports, and then aggregating keyboard data and mouse data into a stream of data elements that are then transmitted to the client docking software. Third, the embedded software provides for user control of the keyboard repeat rate and repeat delay in a manner known in the operating system programming arts.

Fourth, the embedded software is adapted to accommodate a synchronization event. For example, when a synchronization event is detected (typically by pressing the synchronization button 150, but a synchronization may also be initiated in software and in other manners known in the art), keyboard and mouse functions are paused, and the serial USB chip 130 is initiated so that data may pass directly between a PDA coupled to the port 110 and a device coupled to the USB port 132 (in other words, the processor 120 does not participate in the data transfer). The embedded software then detects when the synchronization has concluded and then re-enables/un-pauses the keyboard and mouse data transfers for processing.

The embedded software includes a keyboard interface that accepts signals (typically ASCII values) coming from a keyboard, and then translates those signals into a second set of signals (typically a different set of ASCII values) that are understood by the particular handheld computer that is coupled to the port. Accordingly, when a key is pressed on a keyboard, data is sent to the processor (which may be embodied as a microcontroller). After the processor receives an operation initiated by a key pressed, the processor sends a byte representing the ASCII value of that key out the serial port to the PDA OS, preferably using standard RS232 communications. Some values of the ASCII range are not able to produce characters and should be used for special characters and as an alternative to mouse control.

The embedded software also preferably includes a mouse interface, which receives and translates mouse positioning and input signaling using a similar protocol, and also preferably using ASCII characters. When the mouse is moved or a button is pressed, the data is converted into a series of ASCII characters that distinguish the data from keyboard data. PDA OSs, such as the Palm® OS or the Pocket PC® OS, presently have no idea what to do with a multi-button mouse, so mouse button events are presently preferably interpreted as a single mouse button (ex. left-mouse-down and right-mouse-down are the same). However, as PDA OSs develop, additional button functionality may be developed and falls within the scope of the claims.

Client docking software comprises a driver and a software application, which is preferably implemented as a “.prc” file, and is loaded into a PDA during an installation process (typically the first docking event between a PDA and the cradle 100. The client docking software, in one embodiment, includes a virtual communication driver (VCD) that sits on the PDA. The VCD is a serial driver that continuously monitors serial data received from the embedded software. The VCD is preferably mapped to all PDA applications such that when keyboard data is received, the applications respond as they have received data from a graphiti pad or an on-screen keyboard, for example. In addition, the VCD is preferably mapped to applications such that when mouse data is received, applications respond as if they have received data from a touch screen or a jog dial, for example.

In addition, the client docking software preferably includes a control panel application. The control panel application allows a user to configure settings for a keyboard and/or a mouse. Common configurable settings include a repeat rate, a repeat delay, and a cursor blink rate, for example. Preferably, these settings are adjustable via a slider control, which is known in the art. Other common configurable settings include a hide pointer setting, an enable/disable mouse buttons setting, and an enable/disable scrolling setting, for example. Preferably, these settings are adjustable via a check box, which is known in the art. Adjusting the settings via the client docking software preferably directly changes settings in the embedded software.

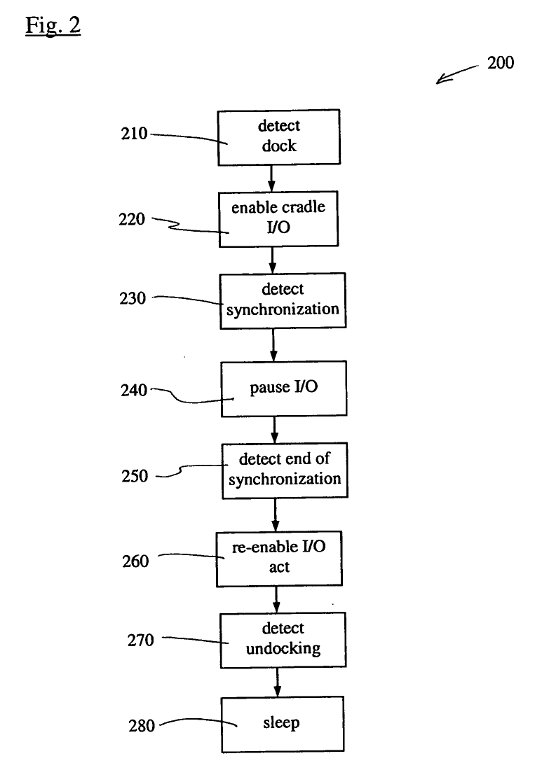

FIG. 2 is a block-flow diagram of a cradle algorithm 200. The following discussion of the cradle algorithm 200 incorporates specifics discussed, above. The cradle algorithm 200 begins with a detect dock act 210 in which the cradle algorithm 200 detects a PDA coupled to a cradle port. Then, in a disable PDA I/O act 210, the PDA inputs are disabled. Next, in an enable cradle I/O act 220, the cradle algorithm 200 enables a keyboard and/or a mouse that is coupled to the cradle to be the primary input device(s) for the PDA. Eventually, a user may initiate a synchronization, which is detected in a detect synchronization act 230, which causes the cradle algorithm 200 to proceed to a pause I/O act 240 in which the mouse and keyboard inputs are paused or otherwise disabled while the PDA and USB-attached device are directly synced together. The cradle algorithm 200 detects the end of the synchronization in a detect end of synchronization act 250, which causes the cradle algorithm 200 to re-enable the keyboard and mouse inputs in a re-enable I/O act 260. Thereafter, eventually the PDA will be undocked and this event is detected in a detect undocking act 270, which initiates a cradle shutdown and sleep mode in a sleep act 280. Of course, it is understood that in the forgoing cradle algorithm 200, cradle cycle view is taken, as any several combinations of the forgoing acts yield new and novel methods of implementing software. Accordingly, any method should be interpreted only as indicated in the claims.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An apparatus, comprising:
a port;
the port adapted to couple with a handheld computer;
a processor coupled to the port;
a second port coupled to the processor;
the second port adapted to communicatively couple with an input device;
the input device comprising a mouse;
the processor having memory; and
the memory stores a code that enables the input device coupled to the second port to communicate with a handheld computer coupled to the port.

2. The apparatus of claim 1 wherein the port is a Universal Serial Palm Connector.

3. The apparatus of claim 1 wherein the processor is an embedded processor.

4. The apparatus of claim 1 wherein the code is adapted to display a cursor on a handheld computer display.

5. The apparatus of claim 1 further comprising a serial USB chip coupled between the processor and a serial USB port.

6. The apparatus of claim 1 wherein the second port is a PS2 port.

7. The apparatus of claim 6 further comprising a sync button coupled to the processor that allows a handheld computer coupled to the port to sync with a device coupled to the serial USB port.

8. The apparatus of claim 1 wherein the second port comprises a USB port.

9. The apparatus of claim 1 further comprising a third port adapted to couple to a second input device.

10. The apparatus of claim 1 wherein the second port is adapted to communicate with an input device via a short range radio signal.

11. The apparatus of claim 1 wherein the memory comprises a keyboard interface that converts a keyboard input value received on the second port into a signal representing that input value for a handheld computer coupled to the port.

12. The apparatus of claim 1 wherein the memory comprises a mouse interface that converts a mouse input value received on the second port into a signal representing that input value for a handheld computer coupled to the port.

13. The apparatus of claim 1 further comprising a virtual communication driver (VCD) in communication with the memory, the VCD resident on a handheld computer.

14. The apparatus of claim 1 wherein the handheld computer is a smart phone.

15. The apparatus of claim 1 wherein the handheld computer is a personal digital assistant.

16. An apparatus, comprising:
a port;
the port adapted to couple with a handheld computer;
a processor coupled to the port;
a second port coupled to the processor;
the second port adapted to communicatively couple with an input device;
a third port;
the third port adapted to couple to a second input device;
the input device comprising a mouse;
the processor having memory; and
the memory stores a code that enables the input device coupled to the second port to communicate with a handheld computer coupled to the port; and
the code is adapted to display a mouse cursor on a handheld computer display.

17. The apparatus of claim 16 wherein the memory comprises a mouse interface that converts a mouse input value received on the second port into a signal representing that input value for a handheld computer coupled to the port.

18. A method in a computer system, comprising:
detecting a docking event on a first port;
automatically enabling an input device coupled to a second port to communicate with a handheld computer coupled to the first port; and
displaying on the handheld computer a cursor whose position is controlled by the input device;
the input device comprising a mouse; wherein
the first port and the second port are maintained on a single cradle.

19. The software system of claim 18 further comprising disabling the input elements of a handheld computing device that is coupled to the first port prior to the act of automatically enabling.

20. The software system of claim 18 further comprising disabling the second port when a sync command is received.
